(19) United States
(12) Patent Application Publication
(10) Pub. No.: US 2026/0168782 A1
(43) Pub. Date: Jun. 18, 2026

(54) ROTATION SENSING DEVICE

(71) Applicant: Hirose Electric Co., Ltd., Yokohama (JP)

(72) Inventor: Kosuke Egawa, Yokohama (JP)

(21) Appl. No.: 19/363,127

(22) Filed: Oct. 20, 2025

(30) Foreign Application Priority Data
Dec. 13, 2024 (JP) 2024-218373

(51) Int. Cl. G01B 7/30; G01B 7/00; G01B 11/26; H02K 11/215

(52) U.S. Cl. CPC G01B 7/30; G01B 7/001; G01B 7/002; G01B 11/26; H02K 11/215

(57) ABSTRACT

A rotation sensing device, comprising a substrate having an insertion hole for a rotary shaft, a magnetic field-generating member rotating with the rotary shaft, a plurality of magnetic sensors disposed around the magnetic field-generating member, a casing which accommodates the plurality of magnetic sensors and is provided on the substrate, an optical sensor provided on the substrate on the side facing away from the plurality of magnetic sensors, and an optical disk which is disposed facing the substrate, with the optical sensor interposed therebetween, and which rotates with the rotary shaft, wherein the device has an adjustment mechanism capable of adjusting the position of the plurality of magnetic sensors relative to the magnetic field-generating member by adjusting the position of the casing relative to the substrate once the position of the optical sensor relative to the optical disk has been adjusted and the substrate has been precisely positioned.

### BACKGROUND

### CROSS-REFERENCE TO RELATED APPLICATIONS

This application claims priority to Japanese Patent Application No. 2024-218373, filed December 13, 2024, the contents of which are incorporated herein by reference in its entirety for all purposes.

### Field

The present invention relates to a rotation sensing device comprising magnetic sensors employing the large Barkhausen effect and an optical sensor.

### Related Art

A magnetic sensor employing the large Barkhausen effect comprises a magnetic wire rod generating the large Barkhausen effect, a bobbin having the magnetic wire rod disposed therein, a coil formed by winding an electrical wire around the bobbin, and two terminals used to connect the coil to external sensing circuitry. The two terminals are respectively secured to the opposite ends of the bobbin. Of the two terminals, one terminal has connected thereto one end of the electrical wire that forms the coil, and the other terminal has connected thereto the other end of the electrical wire that forms the coil. The magnetic sensor is electrically connected to circuits on a substrate, for example, by soldering the respective ends of the two terminals to the substrate. In addition, soldering each terminal secures the magnetic sensor to the substrate and fixes the position of the magnetic sensor on the substrate.

When magnetic sensors are used for sensing the rotation of a rotary shaft, for example, as in the rotation sensing device disclosed in Patent Document 1, magnets are secured to the outer perimeter of the rotary shaft in such a way that a rotating magnetic field is generated on the outer periphery of the rotary shaft as the rotary shaft rotates. Furthermore, multiple magnetic sensors are provided on the substrate, and this substrate is provided on the outer periphery of the rotary shaft in a manner free of contact with either the rotary shaft or the magnets. The multiple magnetic sensors are disposed in proximity to the rotational trajectory of the magnets, at locations different from one another in the direction of rotation of the magnets. This allows for the rotating magnetic field generated by the rotation of the rotary shaft to be sensed by the multiple magnetic sensors and for the amount and direction of rotation, etc., of the rotary shaft to be sensed based on detection signals output from the coil of each magnetic sensor.

### Patent Documents

### Patent Document 1

International Publication No. 2016/021074

### SUMMARY

### Problems to be Solved

For example, when building a rotation sensing device that senses the rotation of a rotary shaft using magnetic sensors, a substrate having the magnetic sensors provided thereon is provided on the outer periphery of the rotary shaft. Conventionally, when such a rotation sensing device is manufactured, first, the magnetic sensors are secured to the substrate by soldering, and the substrate, which has the magnetic sensors secured thereto, is then secured with brackets, support posts, and the like to, for example, a housing, and the like, in which the rotary shaft is rotatably supported.

In order to increase the accuracy with which the rotation of the rotary shaft is sensed by the magnetic sensors, the magnetic sensors need to be disposed in such a way that the position of the magnetic sensors relative to the magnets rotating with the rotary shaft, including the distance between the axis of the rotary shaft and the magnetic sensors, etc., will correspond to the design position. Incidentally, in the course of fabrication of the rotation sensing device, the position of the magnetic sensors relative to the magnets may occasionally deviate from the design position.

It is believed that one of the reasons for the misalignment of the magnetic sensors with respect to the rotary shaft is that the magnetic sensors become misaligned with respect to the substrate during the soldering process in which the magnetic sensors are soldered to the substrate. In addition, another reason for the misalignment of the magnetic sensors with respect to the rotary shaft is that the substrate becomes misaligned with respect to the housing during the substrate attachment process in which the substrate having the magnetic sensors soldered thereto is attached to the housing, etc., in which the rotary shaft is rotatably supported. Accordingly, in order to dispose the magnetic sensors in such a way that the position of the magnetic sensors relative to the rotary shaft will correspond to the design position, both the precise positioning of the magnetic sensors relative to the substrate during the soldering process and the precise positioning of the substrate relative to the housing, etc., during the substrate attachment process must be carried out in a strict and methodical manner. For this reason, it is not easy to dispose the magnetic sensors in such a way that the position of the magnetic sensors relative to the rotary shaft will correspond to the design position.

In addition, in the rotation sensing device, multiple magnetic sensors are accommodated within a casing and the casing is secured to the substrate by attaching it with screws. At such time, in order for the position of the magnetic sensors to correspond to the design position, matching screw holes are provided in the casing and the substrate in a one-to-one relationship. However, since the appropriate position of the magnetic sensors relative to the magnets may vary slightly from device to device depending on the relationship between the magnets and the magnetic sensors, in a configuration in which the casing is secured to the substrate, it is difficult to adjust the magnetic sensors to the appropriate position based on the relationship between the magnets and the magnetic sensors.

In addition, rotation sensing devices include devices comprising magnetic sensors and an optical sensor. In such a case, once the optical sensor has been disposed in the appropriate position according to a relationship between an optical disk rotating with the rotary shaft and the optical sensor, it is difficult to dispose the magnetic sensors in the appropriate positions based on the relationship between the magnets rotating with the rotary shaft and the magnetic sensors.

The present invention was made by paying specific attention to issues such as those described above, and it is an object of the present invention to provide a rotation sensing device allowing for the magnetic sensors and the optical sensor to be readily disposed in such a way that the positions of the magnetic sensors relative to the magnets and of the optical sensor relative to the optical disk will respectively correspond to their design positions.

### Technical Solution

It is an object of the present disclosure to readily dispose magnetic sensors and an optical sensor in such a manner that the positions of the magnetic sensors relative to the magnets and of the optical sensor relative to the optical disk will respectively correspond to their design positions.

In order to eliminate the aforementioned problems, the inventive rotation sensing device, which is a rotation sensing device sensing the rotation of a rotating body, comprises a single substrate having an insertion hole into which the rotating body is inserted, a magnetic field-generating member rotating with the rotation of the rotating body, multiple magnetic sensors disposed around the magnetic field-generating member, a casing which accommodates the multiple magnetic sensors and is provided on the substrate, an optical sensor provided on the substrate on the side facing away from the multiple magnetic sensors, and an optical disk which is disposed facing the substrate, with the optical sensor interposed therebetween, and which rotates with the rotation of the rotating body, and is characterized by having an adjustment mechanism capable of adjusting the position of the multiple magnetic sensors relative to the magnetic field-generating member by adjusting the position of the casing relative to the substrate once the position of the optical sensor relative to the optical disk has been adjusted and the substrate has been precisely positioned.

In accordance with the present invention, the magnetic sensors can be attached by readily adjusting the design positional relationship between the magnetic field-generating member and the magnetic sensors used to sense the rotation of the rotating body simply by attaching the casing to the substrate on which the optical sensor is provided, without affecting the positional relationship between the optical disk and the optical sensor.

In addition, the aforementioned inventive rotation sensing device can comprise coupling members coupling the casing and the substrate, the substrate can have coupling holes through which the coupling members are inserted, and as the adjustment mechanism, the casing can have first adjustment holes which are formed with a diameter larger than that of the coupling members by a predetermined adjustment width and through which the coupling members are inserted.

In addition, in the aforementioned inventive rotation sensing device, as the adjustment mechanism, the casing can have a second adjustment hole which is formed with a diameter larger than that of the insertion hole by a predetermined adjustment width and into which the rotating body and the magnetic field-generating member are inserted.

In addition, in the aforementioned inventive rotation sensing device, the magnetic sensors and the substrate each comprise first terminals and second terminals that are placed in mutual contact and, as the adjustment mechanism, one type of terminal, i.e., the first terminal or second terminal, can be formed as a compression terminal, and the other type of terminal can be formed as a conductor portion whose area of contact is larger than that of the compression terminal by a predetermined adjustment width.

### Technical Effect

The present invention can provide a rotation sensing device allowing for the magnetic sensors and the optical sensor to be readily disposed in such a way that the positions of the magnetic sensors relative to the magnets and of the optical sensor relative to the optical disk will respectively correspond to their design positions.

### BRIEF DESCRIPTION OF THE DRAWINGS

FIG. 1 illustrates a top perspective view of a rotation sensing device according to an embodiment of the present invention.

FIG. 2 illustrates a top plan view of a rotation sensing device according to an embodiment of the present invention.

FIG. 3 illustrates a lateral view of a cross-section of the rotation sensing device taken along section line III–III in FIG. 2.

FIG. 4 illustrates a top plan view of a substrate in a rotation sensing device according to an embodiment of the present invention.

FIG. 5 illustrates a top plan view of a magnetic sensor device in a rotation sensing device according to an embodiment of the present invention.

FIG. 6 illustrates a bottom plan view of a magnetic sensor device in a rotation sensing device according to an embodiment of the present invention.

FIG. 7 illustrates a top plan view of magnetic sensors and yokes in a rotation sensing device according to an embodiment of the present invention.

FIG. 8 illustrates a top perspective view of magnetic sensors and yokes in a rotation sensing device according to an embodiment of the present invention.

FIG. 9 illustrates a top perspective view of a magnetic sensor in a rotation sensing device according to an embodiment of the present invention.

FIG. 10 illustrates a bottom perspective view of a magnetic sensor in a rotation sensing device according to an embodiment of the present invention.

FIG. 11 illustrates a top perspective view of a magnetic sensor in a rotation sensing device according to an embodiment of the present invention, with the coil removed.

FIG. 12 illustrates a top perspective view of a magnetic sensor terminal in a rotation sensing device according to an embodiment of the present invention.

FIG. 13 illustrates an illustrative view of a method for precisely positioning the magnetic sensor device in a rotation sensing device according to an embodiment of the present invention.

FIG. 14 illustrates a top perspective view of a magnetic sensor terminal in a rotation sensing device according to another embodiment of the present invention.

### DETAILED DESCRIPTION

### Rotation Sensing Device

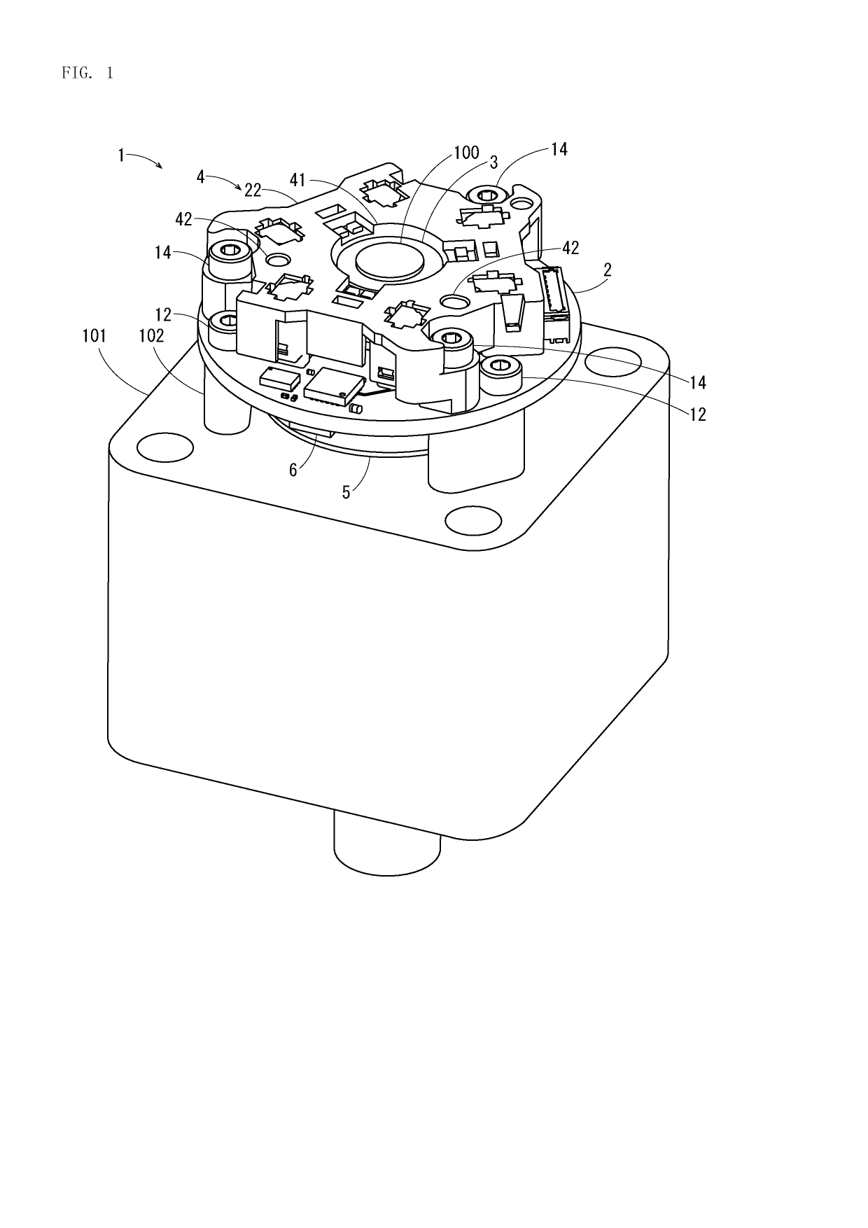

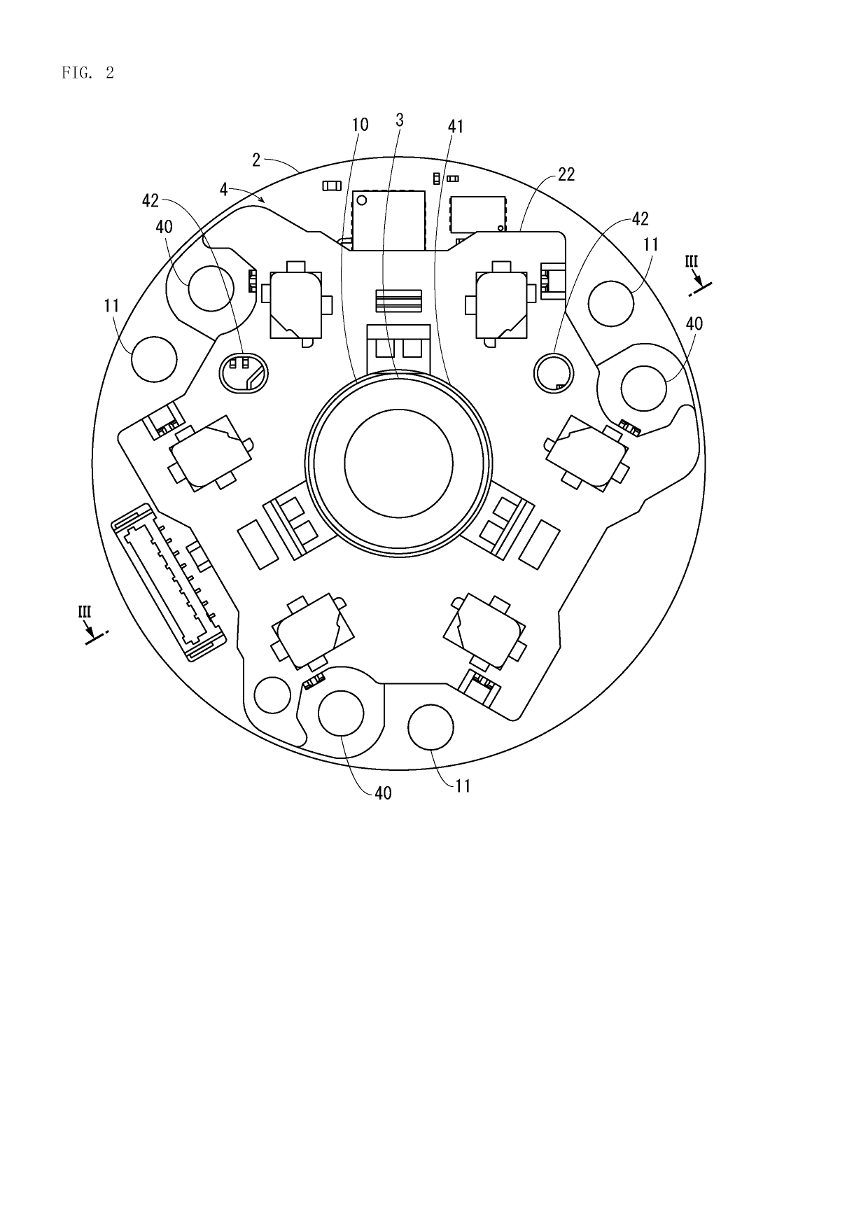

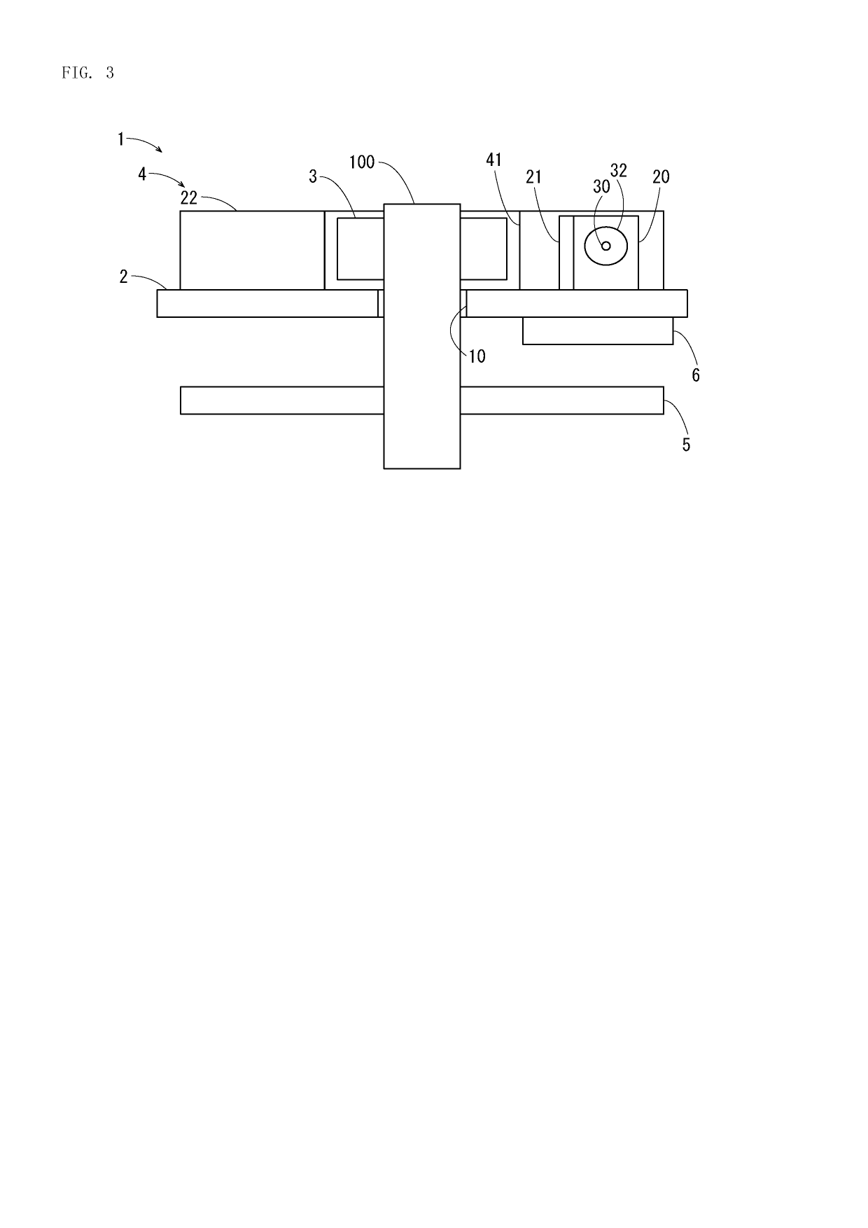

A rotation sensing device 1 according to an embodiment of the present invention will now be described with reference to the drawings. FIG. 1 is a top perspective view of the rotation sensing device 1, and FIG. 2 is a top plan view of the rotation sensing device 1. FIG. 3 is a lateral (top left in FIG. 2) view of a cross-section of the rotation sensing device 1 taken along section line III–III in FIG. 2.

The rotation sensing device 1 is a device sensing the rotation of a rotary shaft 100 that serves as a rotating body. For example, the rotary shaft 100 is the output shaft of a motor, and the rotation sensing device 1 is assembled with said motor. The rotary shaft 100, which is rotatably supported by the motor, protrudes upwardly from the top face of the housing 101 of the motor.

The rotation sensing device 1 comprises a single substrate 2, a magnetic field-generating member 3 generating a rotating magnetic field, a magnetic sensor device 4 sensing the rotating magnetic field, an optical disk 5 generating light to be sensed, and an optical sensor 6 sensing the light to be sensed.

### Substrate

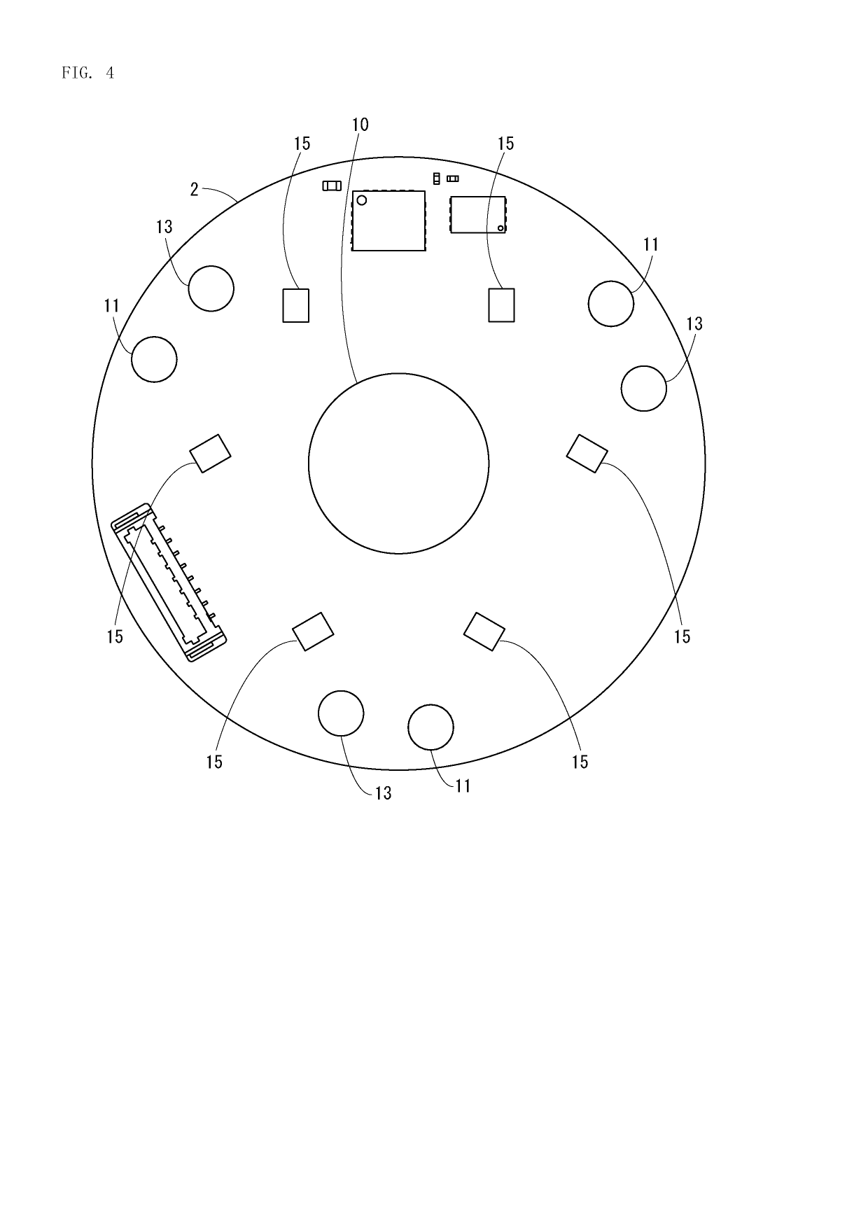

The substrate 2 is provided at the outer periphery of the rotary shaft 100 and in proximity to the magnetic field-generating member 3. FIG. 4 is a top plan view of the substrate 2. The substrate 2, which is formed in a disk-like configuration, is disposed in an orientation in which the plane thereof is perpendicular to the rotational axis of the rotary shaft 100.

A round insertion hole 10 is formed coaxially with the rotary shaft 100 in the central portion of the substrate 2, and the rotary shaft 100 is inserted within the insertion hole 10. The insertion hole 10 is formed with a diameter larger than the outside diameter of the magnetic field-generating member 3 provided around the periphery of the rotary shaft 100, and the substrate 2 is disposed in such a way that the rotary shaft 100 and the magnetic field-generating member 3 do not come into contact with the edge of the insertion hole 10, i.e., the substrate 2. Once the rotary shaft 100 has been inserted into the insertion hole 10, the substrate 2 is secured to the housing 101 of the motor through the medium of support posts 102.

The substrate 2 has securing holes 11 through which bolts and other securing members 12 are inserted, and is secured to the housing 101 by securing the securing members 12 inserted through the securing holes 11 to the support posts 102. The securing holes 11 are formed with a diameter that is generally the same as the diameter of the shaft portions of the securing members 12.

In addition, for coupling to the magnetic sensor device 4, the substrate 2 has coupling holes 13 through which bolts and other coupling members 14 are inserted, and the coupling members 14, which are inserted through the magnetic sensor device 4 (first adjustment holes 40) and the coupling holes 13, are secured to the support posts 102. The coupling holes 13 are formed with a diameter that is generally the same as the diameter of the shaft portions of the coupling members 14.

Electrical and electronic components other than the magnetic sensor device 4 are mounted to the top and bottom faces of the substrate 2 by soldering and the like. Pads and other conductor portions 15 (second terminals) used for electrically connecting to the magnetic sensor device 4 are mounted, for example, to the top face of the substrate 2. Specifically, the conductor portions 15 are disposed in alignment with terminals 33 (first terminals) provided in the magnetic sensors 20 of the magnetic sensor device 4, and are formed such that they have an area of contact larger than that of the terminals 33 by a predetermined adjustment width. For example, for terminals 33 with dimensions of about 0.6 mm, the conductor portions 15 are formed such that they have an area of contact measuring about 2 mm by 2 mm. In addition, an optical sensor 6 is mounted to the bottom face of the substrate 2.

### Magnetic Field-Generating Member

The magnetic field-generating member 3 is formed in an annular configuration from, for example, ferrite or other magnetic materials. After having been disposed on the outer periphery of the rotary shaft 100 coaxially with the rotary shaft 100 and having been secured to the rotary shaft 100, the magnetic field-generating member 3 rotates with the rotation of the rotary shaft 100. The magnetic field-generating member 3 is disposed on top of the substrate 2 inwardly of the magnetic sensors 20 of the magnetic sensor device 4. The magnetic field-generating member 3 is a multipole-magnetized magnet with four magnetic poles, i.e., an N pole, an S pole, an N pole, and an S pole, formed, in that order, in the outer peripheral section of the magnetic field-generating member 3 at, for example, 90-degree intervals in the circumferential direction of the magnetic field-generating member 3. Alternatively, the magnetic field-generating member 3 may be formed from four magnets that have not been multipole magnetized.

Due to the fact that the magnetic field-generating member 3 is rotating with the rotation of the rotary shaft 100 when a magnetic field is to be generated on the outer periphery of the magnetic field-generating member 3, the magnetic field generated by the magnetic field-generating member 3 is set in rotation. This forms a rotating magnetic field that rotates about the axis of rotation of the rotary shaft 100.

### Magnetic Sensor Device

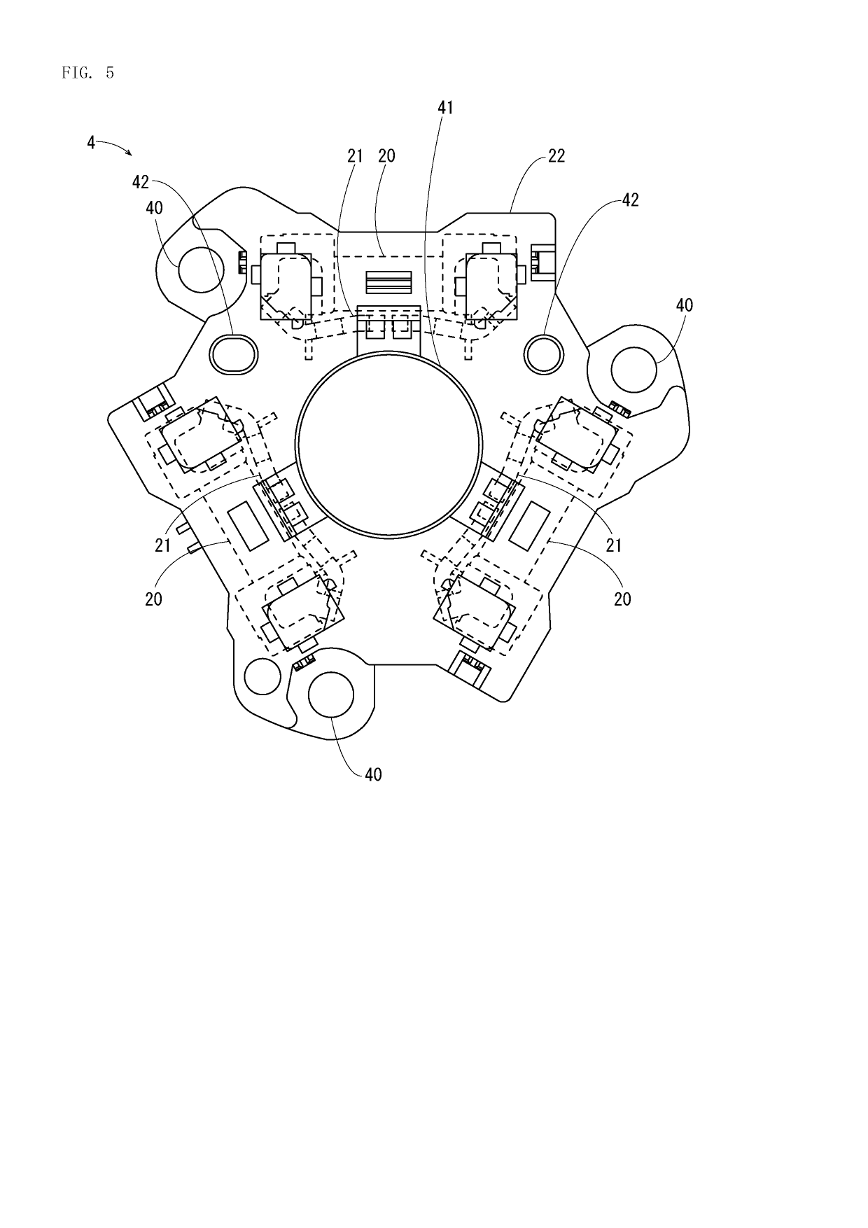

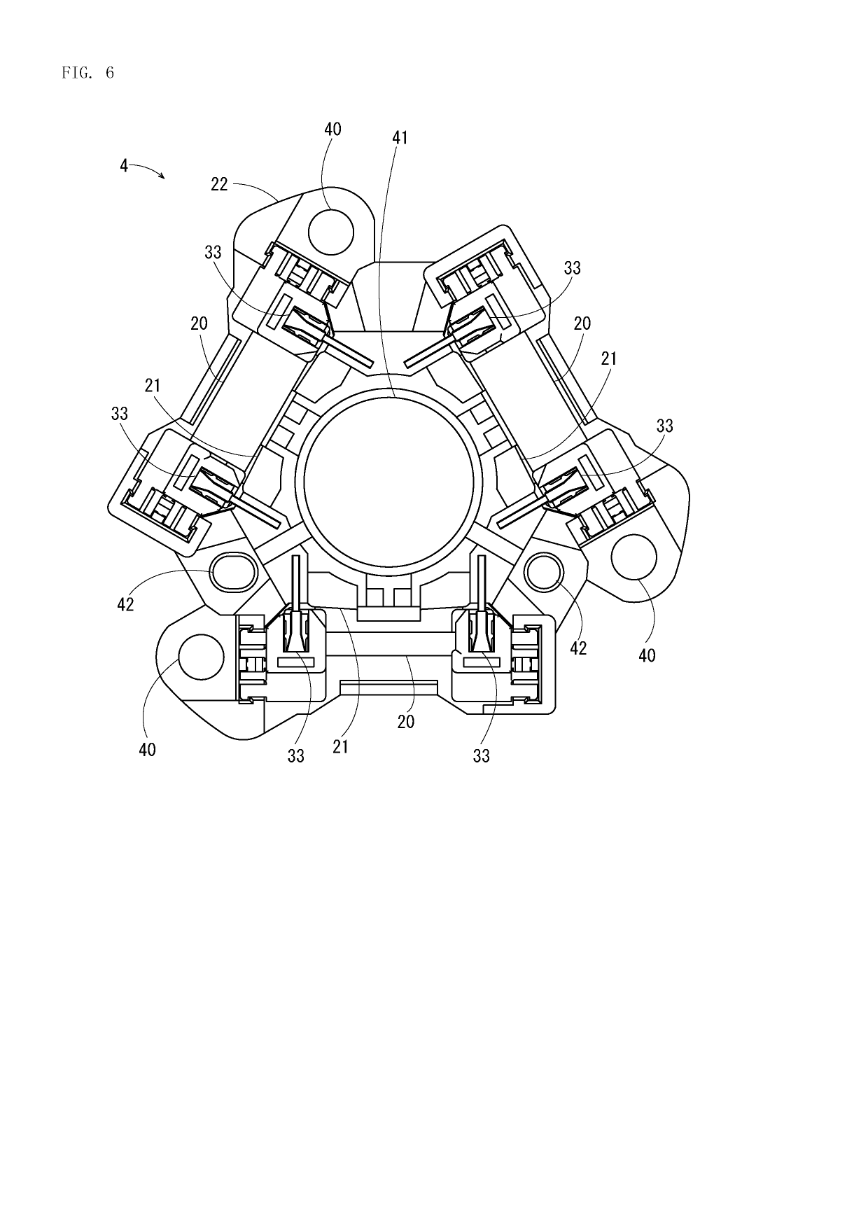

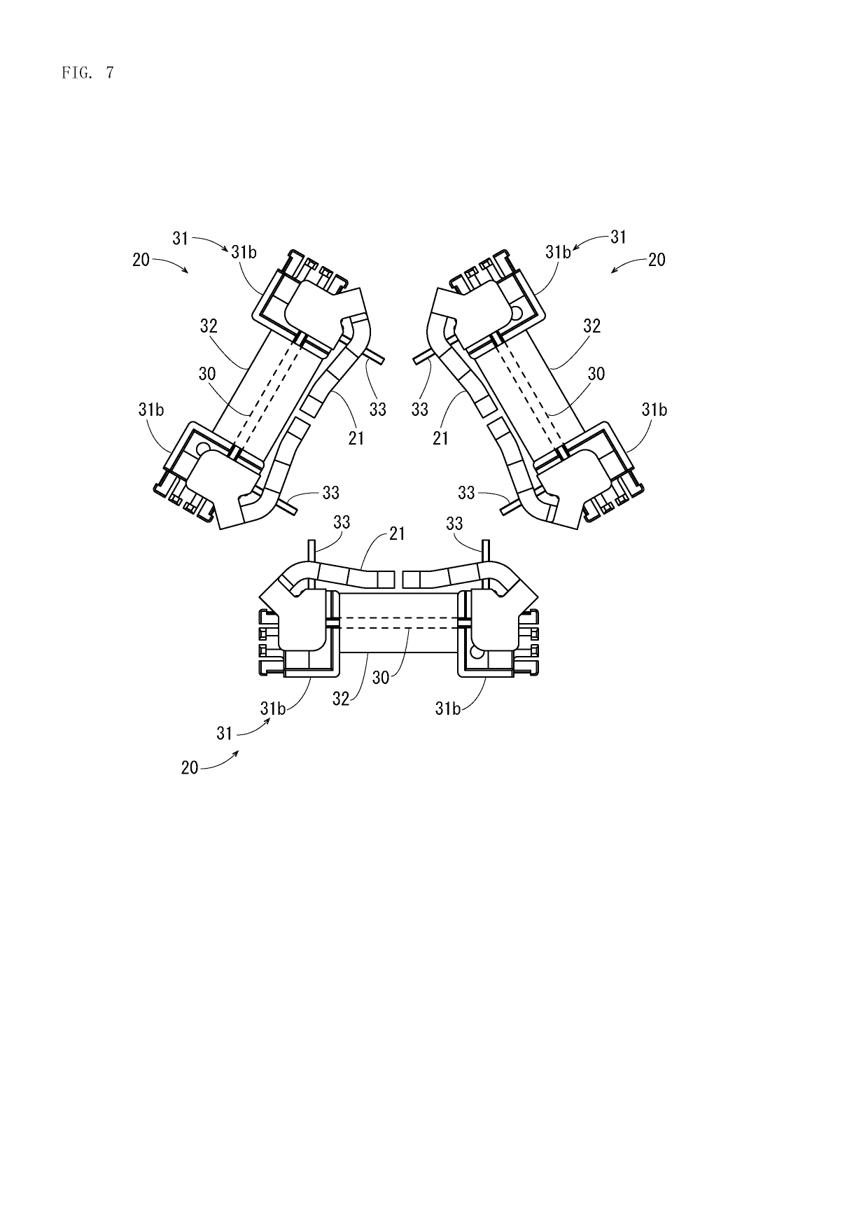

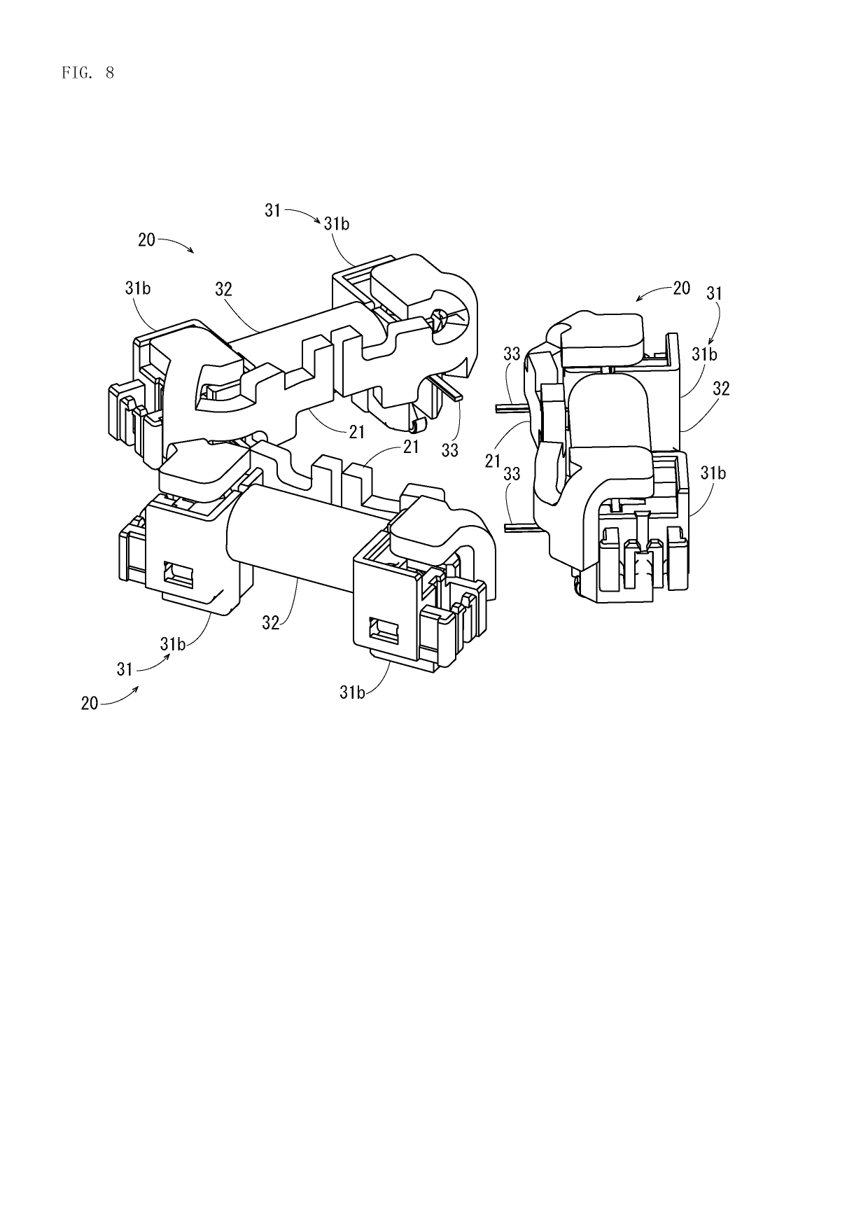

FIG. 5 is a top plan view of the magnetic sensor device 4, and FIG. 6 is a bottom plan view of the magnetic sensor device 4. The magnetic sensor device 4 comprises multiple magnetic sensors 20 (three magnetic sensors 20 in the present embodiment), multiple yokes 21 (three yokes 21 in the present embodiment), and one casing 22. The magnetic sensor device 4 is disposed on the top face of the substrate 2. FIG. 7 is a top plan view of the three magnetic sensors 20 and three yokes 21, and FIG. 8 is a top perspective view of the three magnetic sensors 20 and three yokes 21.

The three magnetic sensors 20, which sense the rotating magnetic field generated by the magnetic field-generating member 3, are identical to one another. The three yokes 21, which control the direction of the magnetic flux of the magnetic field generated by the magnetic field-generating member 3, are identical to one another. The magnetic sensor device 4 is formed as a unitary body by accommodating and securing the three magnetic sensors 20 and three yokes 21 within a single casing 22. For example, the three magnetic sensors 20 are attached by respectively mating with three sensor receiving holes provided in the bottom face of the casing 22, and the three yokes 21 are embedded within the casing 22 via insert molding. Within the casing 22, the three magnetic sensors 20 are disposed in a single reference plane positioned coplanar with the bottom face of the casing 22. In FIG. 5, the three magnetic sensors 20 and three yokes 21 accommodated within the casing 22 are shown in dashed lines.

As described below, in the casing 22, the magnetic sensor device 4 has multiple round first adjustment holes 40 corresponding to the coupling holes 13 in the substrate 2, and a round second adjustment hole 41 corresponding to the insertion hole 10 in the substrate 2. The casing 22 will be described below in detail. Once the second adjustment hole 41 has been aligned with the insertion hole 10 and, in addition, the first adjustment holes 40 have been aligned with the coupling holes 13, the magnetic sensor device 4 is disposed on the substrate 2 by allowing the bottom face of the casing 22 to rest on the substrate 2. In addition, as a result of securing the coupling members 14 inserted through the first adjustment holes 40 and the coupling holes 13 to the support posts 102, the magnetic sensor device 4 is coupled to the substrate 2 and secured to the housing 101.

Once the magnetic sensor device 4 has been disposed on the substrate 2 in this manner, the three magnetic sensors 20 and three yokes 21 are disposed on the substrate 2. The three magnetic sensors 20 are disposed radially outward of the second adjustment hole 41, at 120-degree intervals in the circumferential direction around the second adjustment hole 41. The three yokes 21 are disposed in one-to-one correspondence with the three magnetic sensors 20, with each yoke 21 disposed radially inward of the corresponding magnetic sensor 20 in such a manner as to lie adjacent to said magnetic sensor 20. In the same manner as the three magnetic sensors 20, the three yokes 21 are disposed radially outward of the second adjustment hole 41, at 120-degree intervals in the circumferential direction around the second adjustment hole 41.

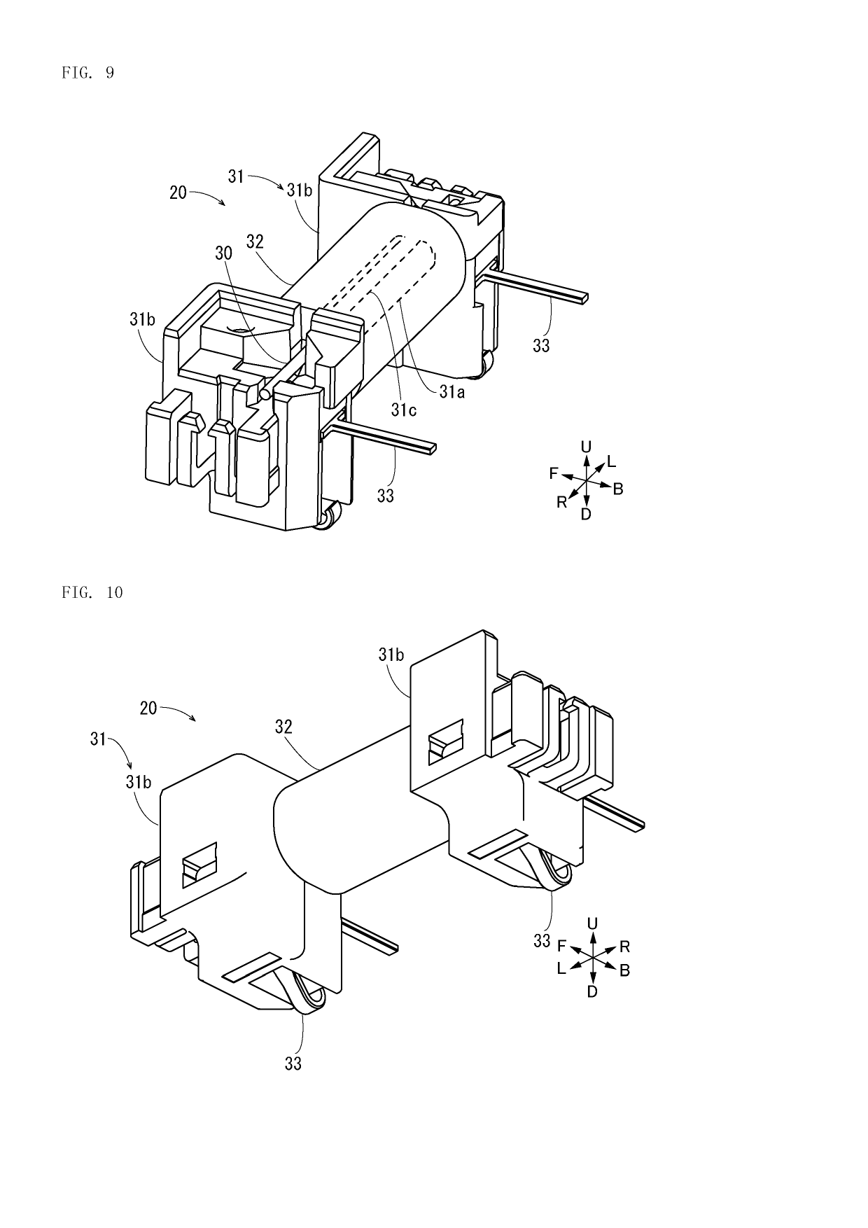

As shown in FIG. 9 and FIG. 10, each magnetic sensor 20 has a magnetic wire rod 30 generating the large Barkhausen effect. Each magnetic sensor 20 is disposed in such a manner that the direction of extension of the magnetic wire rod 30 is parallel to the plane of the substrate 2 and, as viewed from above, the central portion of the magnetic wire rod 30 in the direction of extension is tangential to a predefined circle coaxial with the second adjustment hole 41 located radially outward of the magnetic field-generating member 3.

The three magnetic sensors 20 and three yokes 21 are disposed in a manner to be free of contact with the magnetic field-generating member 3. Whereas the magnetic field-generating member 3 rotates with the rotary shaft 100, which rotates relative to the housing 101, the magnetic sensor device 4 disposed on the substrate 2 remains stationary and does not rotate relative to the housing 101. The three magnetic sensors 20 provided in the magnetic sensor device 4 sense the rotating magnetic field generated around the periphery of the magnetic field-generating member 3. Specifically, due to the rotation of the magnetic field generated by the magnetic field-generating member 3, the direction of the magnetic field acting on each magnetic sensor 20 varies, and each magnetic sensor 20 outputs pulse signals corresponding to the changes in the direction of this magnetic field. The magnetic sensor device 4 senses the amount and direction, etc., of rotation of the rotary shaft 100 based on the pulse signals output from each magnetic sensor 20.

Each yoke 21 is formed, for example, from iron or other soft magnetic materials. Each yoke 21 controls the direction of magnetic flux in such a way that the magnetic flux of the magnetic field generated by the two magnetic poles of the magnetic field-generating member 3 at the opposite ends in the direction of extension of the magnetic wire rod 30 of the magnetic sensor 20 is focused on the magnetic wire rod 30. Each yoke 21 causes the magnetic flux to flow in the direction of extension of the magnetic wire rod 30 and, in addition, ensures that the magnetic flux passes through the magnetic wire rod 30.

### Magnetic Sensors

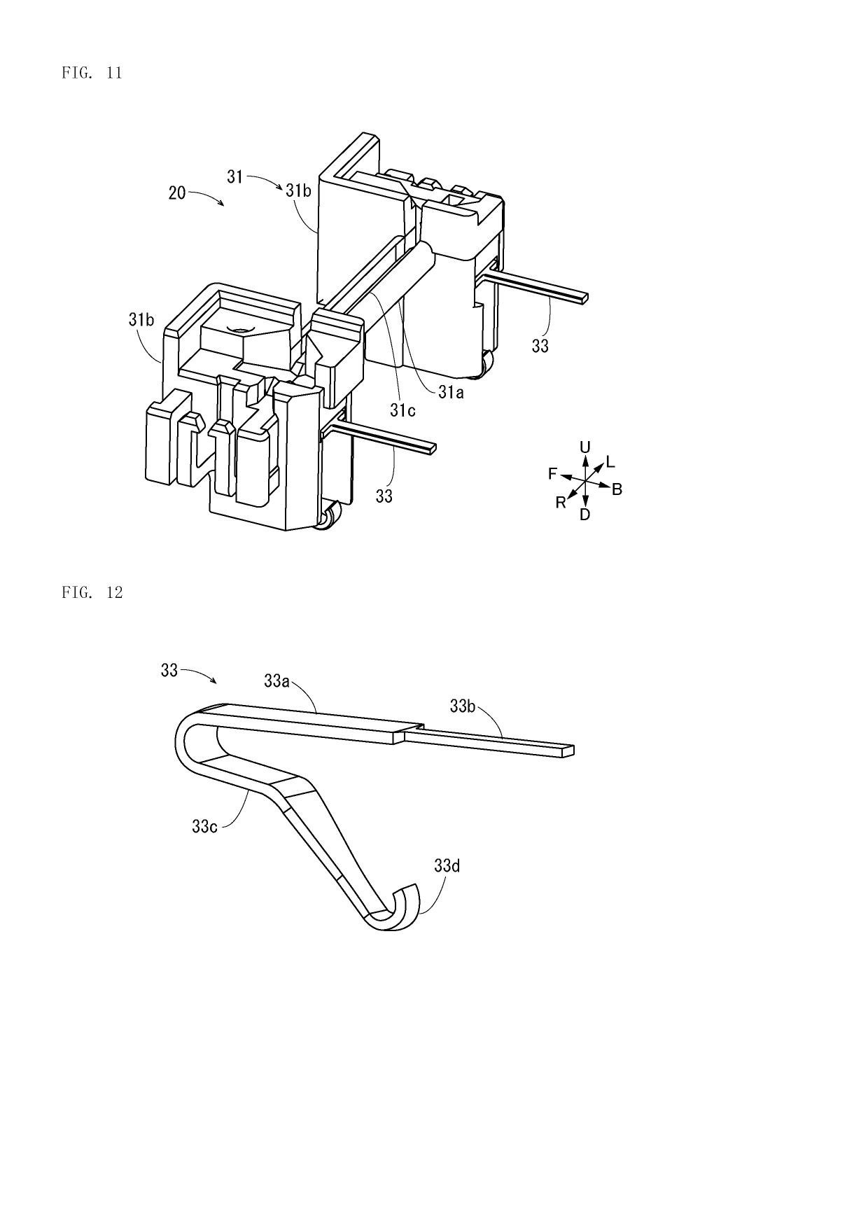

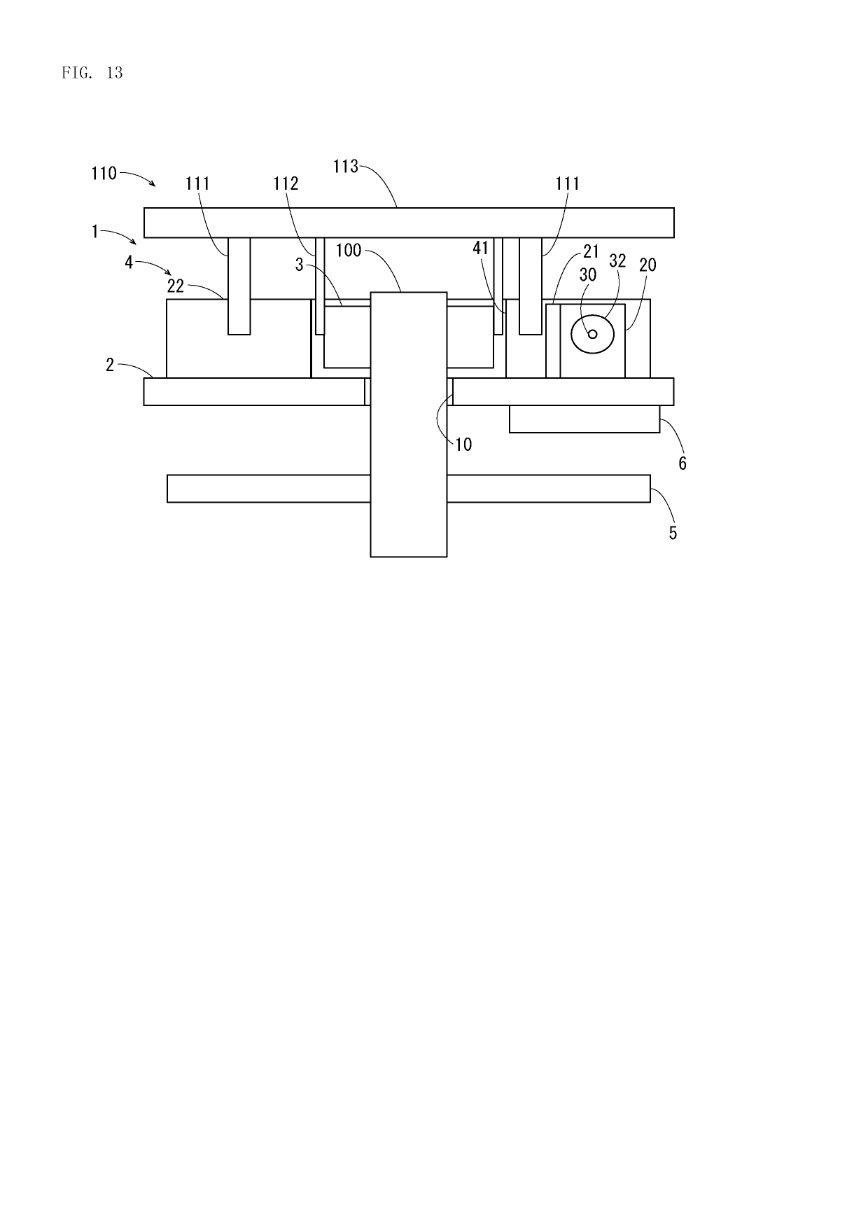

FIG. 9 is a top perspective view of a single magnetic sensor 20, and FIG. 10 is a bottom perspective view of a single magnetic sensor 20. For ease of discussion, the directions associated with the magnetic sensor 20, such as forward (F), back (B), up (U), down (D), left (L), and right (R), are defined as indicated by the arrows depicted in FIGS. 9 and 10. The magnetic sensor 20 comprises a magnetic wire rod 30, a bobbin 31, a coil 32, and two terminals 33 (first terminals). FIG. 11 is a top perspective view of a single magnetic sensor 20, with the coil 32 removed, and FIG. 12 is a perspective view of a terminal 33.

The magnetic wire rod 30 is a composite magnetic wire generating the large Barkhausen effect. The magnetic wire rod 30 is a wire rod that is formed, for example, from a semi-rigid magnetic material including iron and cobalt, and has a diameter of about 0.1 mm to 1 mm and a length of about 10 mm to 30 mm. The magnetic wire rod 30 is formed, for example, by drawing the above-mentioned semi-rigid magnetic material and twisting it multiple times while changing the direction. The magnetic wire rod 30 possesses uniaxial anisotropy in which the easy direction of magnetization is the direction of the central axis of said magnetic wire rod 30. In the magnetic wire rod 30, the coercivity of the central section is larger than the coercivity of the outer peripheral section. The magnetic wire rod 30 has a property whereby the direction of magnetization of the magnetic wire rod 30 (outer peripheral section) is abruptly reversed in response to changes in the direction of an external magnetic field.

The bobbin 31 is formed, for example, from plastics or other nonmagnetic materials in a bilaterally symmetrical fashion. The bobbin 31 comprises a wire winding portion 31a and two wire rod supporting portions 31b. The wire winding portion 31a, which is provided in the intermediate portion of the bobbin 31 in the left-to-right direction, is formed in a columnar configuration extending in the left-to-right direction. The wire rod supporting portions 31b are provided respectively in the left and right end portions of the bobbin 31 and, specifically, are formed as extensions of the opposite left and right ends of the wire winding portion 31a. A wire rod receiving groove 31c extending from the left to the right end is provided in the bobbin 31 through the left-hand wire rod supporting portion 31b, the wire winding portion 31a, and the right-hand wire rod supporting portion 31b.

The magnetic wire rod 30 is disposed in such a manner as to extend rectilinearly in a left-to-right direction inside the bobbin 31 and, specifically, is disposed within the wire rod receiving groove 31c of the wire winding portion 31a. The left end portion of the magnetic wire rod 30 is supported (secured) in the left end portion of the wire rod receiving groove 31c by adhesive bonding and other means, and the right end portion of the magnetic wire rod 30 is supported (secured) in the right end portion of the wire rod receiving groove 31c in the same manner. Alternatively, a wire rod receiving hole extending from the left to the right end of the bobbin 31 can be provided instead of the wire rod receiving groove 31c, and the magnetic wire rod 30 can be disposed within the wire rod receiving hole.

The coil 32 is provided on the outer periphery of the magnetic wire rod 30 disposed within the wire rod receiving groove 31c. Specifically, the coil 32 is formed by winding an insulated electric wire such as, for example, an enameled wire around the wire winding portion 31a.

Each terminal 33 is a compression terminal. It should be noted that compression terminals may sometimes be referred to as “spring terminals.” Each terminal 33 is formed from electrically conductive materials, for example, metallic materials. Each terminal 33 comprises a base portion 33a, an electrical wire connecting portion 33b, a spring portion 33c, and a contact portion 33d.

The base portion 33a is formed in the shape of a plate elongated in the forward-backward direction. The electrical wire connecting portion 33b is formed extending rearwardly from the rear end portion of the base portion 33a, and has an end portion of the insulated wire of the coil 32, stripped of its insulating jacket, connected thereto. The electrical wire connecting portion 33b of one terminal 33 of the two terminals 33 has one end of the insulated electrical wire connected thereto, and the electrical wire connecting portion 33b of the other terminal 33 has the other end of the insulated electrical wire connected thereto. The spring portion 33c, which is a flat spring used to displace the contact portion 33d in the up-down direction, is bent, for example, downwardly from the front end portion of the base portion 33a and, subsequently, bent rearwardly and, after that, extends rearwardly while sloping downward. The contact portion 33d is a section that makes contact with a conductor portion 15 provided on the top face of the substrate 2 when the magnetic sensor device 4 is coupled to the substrate 2. The contact portion 33d is provided at the rear bottom end of the spring portion 33c and, for example, is formed to curve upwardly from the rear bottom end of the spring portion 33c.

The two terminals 33 are provided respectively in the bottom portions of the two wire rod supporting portions 31b of the bobbin 31. Once each terminal 33 has been disposed in each wire rod supporting portion 31b, the rear ends of the electrical wire connecting portions 33b protrude rearwardly from the rear faces of the wire rod supporting portions 31b. The contact portions 33d are usually disposed in such a manner as to protrude downwardly from the bottom faces of the wire rod supporting portions 31b while being displaced upwardly against the resilient force of the spring portion 33c and push-fitted into the wire rod supporting portions 31b under pressure applied from below. For example, when the magnetic sensor device 4 is disposed on the substrate 2, the contact portions 33d are pushed against the conductor portions 15 on the substrate 2, as a result of which the position of the bottom faces of the contact portions 33d coincides with the position of the bottom faces of the wire rod supporting portions 31b and, in addition, the contact portions 33d are pressed against the conductor portions 15 by the resilient force of the spring portion 33c and make forceful contact with the conductor portions 15, thereby establishing a reliable electrical connection to the conductor portions 15.

### Optical Disk and Optical Sensor

The optical disk 5 is disposed in such a manner as to rotate with the rotary shaft 100, which rotates relative to the housing 101, and the optical sensor 6 is disposed in a stationary manner and does not rotate relative to the housing 101.

The optical disk 5 is formed, for example, from plastics or other nonmagnetic materials in a disk-like configuration. The optical disk 5 is attached and secured to the peripheral surface of the rotary shaft 100 below the substrate 2 in an orientation in which the plane thereof is perpendicular to the axis of rotation of the rotary shaft 100. The optical disk 5 is disposed facing the substrate 2 with the optical sensor 6, which is provided on the substrate 2, interposed therebetween. Specifically, the optical disk 5, on its top face opposing the bottom face of the substrate 2, has multiple reflective portions (not shown) that reflect light to be sensed and multiple non-reflective portions (not shown) that do not reflect the light to be sensed. The multiple reflective portions and multiple non-reflective portions are arranged in an alternating manner in the circumferential direction of the optical disk 5.

The optical sensor 6 comprises, for example, a light-emitting diode or another light emitter (not shown) that emits illumination light, and a phototransistor or another light receiver (not shown) that receives light to be sensed and performs photoelectric conversion. The optical sensor 6 is attached and secured to the bottom face of the substrate 2 in such a manner as to emit illumination light onto the top face of the optical disk 5 and receive light to be sensed reflected by the top face of the optical disk 5.

### Casing

The casing 22 of the magnetic sensor device 4 will be described in detail hereinbelow. The casing 22 is formed, for example, from plastics or other nonmagnetic materials. As mentioned above, along with having multiple round first adjustment holes 40 corresponding to the coupling holes 13 in the substrate 2 for coupling the casing 22 (magnetic sensor device 4) to the substrate 2 with the help of bolts or other coupling members 14, the casing 22 has a round second adjustment hole 41 corresponding to the insertion hole 10 in the substrate 2 for inserting the magnetic field-generating member 3 and the rotary shaft 100. In the casing 22 of the present embodiment, the second adjustment hole 41 is provided in the central portion of the casing 22, and the three first adjustment holes 40 are disposed in the outer peripheral section of the casing 22 at 120-degree intervals in the circumferential direction around the second adjustment hole 41.

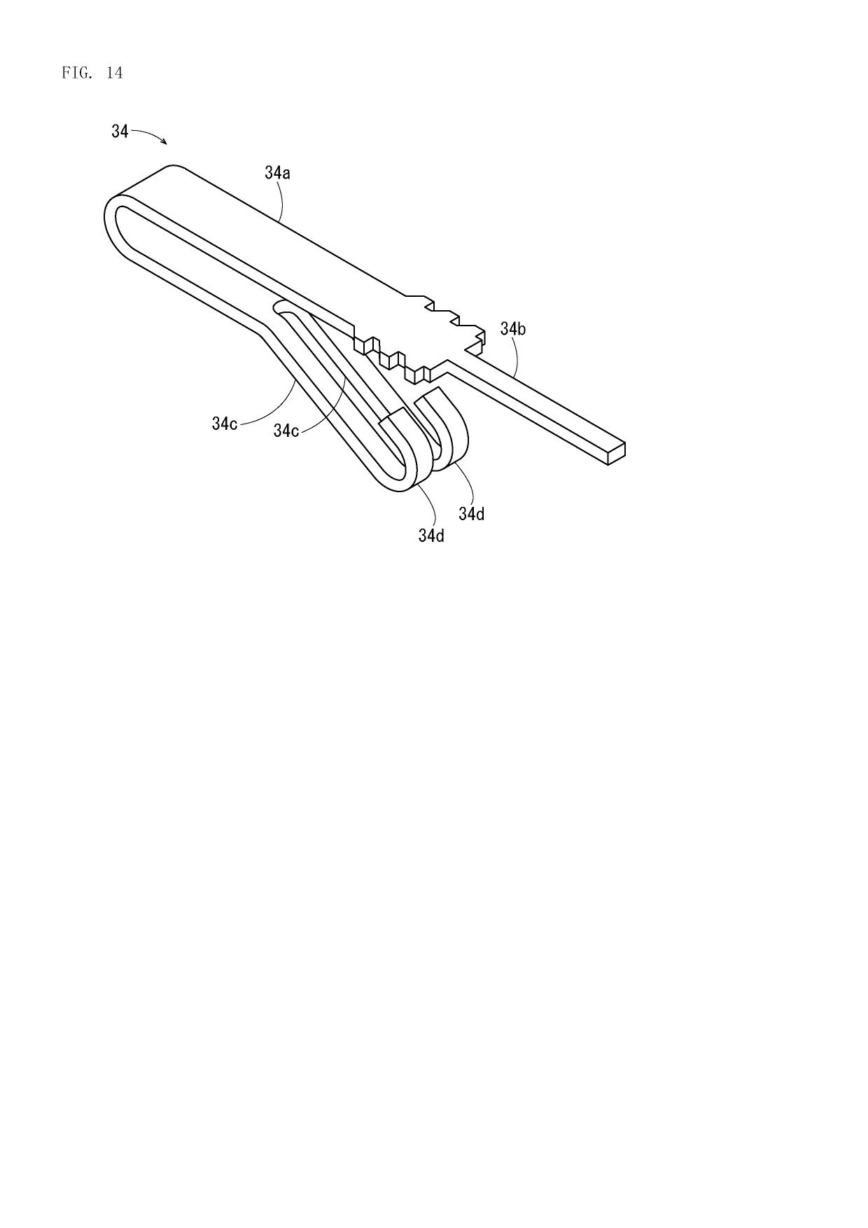

In addition, on the top face thereof, the casing 22 has multiple positioning reference holes 42 used for precise positioning relative to the substrate 2. At least two positioning reference holes 42 can be formed as the multiple positioning reference holes 42 around the periphery of the second adjustment hole 41. The multiple positioning reference holes 42 are formed in such a manner that multiple positioning bosses 111 of a dedicated positioning jig 110, such as the one illustrated in FIG. 13, are respectively inserted therein. It should be noted that there are no restrictions on the placement of the multiple positioning reference holes 42.

In addition to the multiple positioning bosses 111, the positioning jig 110 has a fitting cylinder 112 that fits the outer shape of the magnetic field-generating member 3. The design positional relationship between the magnetic sensors 20 and the magnetic field-generating member 3 varies depending on the type and individual characteristics of the motor and the magnetic sensor device 4. Since the positional relationship between the multiple positioning reference holes 42 and the magnetic field-generating member 3 is determined in accordance with the design positional relationship between the magnetic sensors 20 and the magnetic field-generating member 3, the positioning jig 110 is built by determining the positional relationship between the multiple positioning bosses 111 and the fitting cylinder 112 in accordance with the positional relationship between the multiple positioning reference holes 42 and the magnetic field-generating member 3.

Once the magnetic field-generating member 3 has been disposed inside the second adjustment hole 41, the coupling members 14 inserted through the first adjustment holes 40 and the coupling holes 13 are secured to the support posts 102, thereby securing the casing 22 to the substrate 2 and the housing 101. As a result of securing the casing 22 to the substrate 2 and the housing 101, the multiple magnetic sensors 20 are precisely positioned relative to the magnetic field-generating member 3 disposed inside the second adjustment hole 41.

In addition, the casing 22 has an adjustment mechanism capable of adjusting the position of the multiple magnetic sensors 20 relative to the magnetic field-generating member 3 by adjusting the position of the casing 22 relative to the substrate 2 once the position of the optical sensor 6 relative to the optical disk 5 has been adjusted to the design position and the substrate 2 has been precisely positioned.

As the adjustment mechanism, the casing 22 has first adjustment holes 40 formed with a diameter larger than that of the coupling members 14 (coupling holes 13 in the substrate 2) by a predetermined adjustment width. In addition, as the adjustment mechanism, the casing 22 has a second adjustment hole 41 formed with a diameter larger than that of the insertion hole 10 in the substrate 2 by a predetermined adjustment width.

In other words, compared to the placement where the coupling members 14 inserted through the coupling holes 13 and the first adjustment holes 40 are coaxially aligned, the casing 22 allows for positional adjustment relative to the substrate 2 in a direction parallel to the plane of the substrate 2 (in a direction perpendicular to the direction of insertion of the coupling members 14) with a degree of freedom defined by the adjustment width of the first adjustment holes 40 serving as the adjustment mechanism. Here, the casing 22 allows for positional adjustment relative to the substrate 2 in a direction parallel to the plane of the substrate 2 so as to maintain a sufficient clearance (e.g., a predetermined distance or more) from the magnetic field-generating member 3, with a degree of freedom defined by the adjustment width of the second adjustment hole 41, without permitting contact between the magnetic field-generating member 3 surrounding the rotary shaft 100 inserted through the insertion hole 10 and the second adjustment hole 41.

### Assembly of Substrate and Magnetic Sensor Device

The method that is used to assemble the substrate 2 and the magnetic sensor device 4 with the housing 101 of the motor in order to form the rotation sensing device 1 is as follows.

First, electrical and electronic components other than the magnetic sensor device 4 are mounted to the substrate 2; for example, conductor portions 15 are mounted to the top face of the substrate 2 and an optical sensor 6 is mounted to the bottom face of the substrate 2.

Next, an optical disk 5 is disposed on the outer periphery of the rotary shaft 100, and the optical disk 5 is secured to the rotary shaft 100.

In addition, the substrate 2, to which the electrical and electronic components other than the magnetic sensor device 4 have been mounted, is disposed at the outer periphery of the rotary shaft 100. Here, the substrate 2 is disposed in such a way as to coaxially align the insertion hole 10 in the substrate 2 with the rotary shaft 100 and the magnetic field-generating member 3, and, furthermore, the position of the optical sensor 6 with respect to the optical disk 5 attached to the rotary shaft 100 is adjusted to the design position and the substrate 2 is precisely positioned. The substrate 2 is then attached and secured to the housing 101 of the motor with the help of the support posts 102.

Next, the casing 22 of the magnetic sensor device 4 that accommodates the three magnetic sensors 20 and three yokes 21 is disposed and precisely positioned on the top face of the substrate 2 at the outer periphery of the rotary shaft 100 and the magnetic field-generating member 3. Here, the casing 22 can be disposed in such a manner as to align the first adjustment holes 40 in the casing 22 with the coupling holes 13 in the substrate 2 and can be pre-positioned by inserting coupling members 14, without tightening, through the first adjustment holes 40 in the casing 22 and the coupling holes 13 in the substrate 2.

The precise positioning of the casing 22 relative to the substrate 2 is performed, for example, with the help of a dedicated positioning jig 110. The positioning jig 110 is configured to have multiple positioning bosses 111 and a fitting cylinder 112 on the bottom face of a base 113. By working the positioning jig 110 onto the casing 22, multiple positioning bosses 111 are inserted through the multiple positioning reference holes 42 in the casing 22 and the fitting cylinder 112 is fitted over the outer shape of the magnetic field-generating member 3, as a result of which the casing 22, i.e., the magnetic sensor device 4, is precisely positioned relative to the substrate 2 in such a manner that the multiple magnetic sensors 20 accommodated in the casing 22 and the magnetic field-generating member 3 are arranged in the predetermined design positional relationship.

Once the magnetic sensor device 4 has been precisely positioned on the substrate 2, each terminal 33 of each magnetic sensor 20 makes contact with a conductor portion 15 mounted to the top face of the substrate 2. At such time, as a form of the above-described adjustment mechanism, the conductor portions 15 have an area of contact larger than that of the terminals 33, and therefore contact with the terminals 33 can be maintained even if the casing 22 is adjusted in the horizontal direction when positioning. In addition, when the terminals 33 make contact with the conductor portions 15, the contact portions 33d are pushed by the conductor portions 15, the spring portions 33c undergo resilient deformation, and the contact portions 33d are upwardly displaced, as a result of which the contact portions 33d push forcefully against the conductor portions 15 and the contact portions 33d are reliably electrically connected to the conductor portions 15.

Once the casing 22 has been precisely positioned, the coupling members 14 inserted through the first adjustment holes 40 in the casing 22 and the coupling holes 13 in the substrate 2 are tightened and secured to the housing 101 of the motor.

In this manner, once precise positioning of the optical disk 5 attached to the rotary shaft 100 and the optical sensor 6 attached to the substrate 2 has been performed, the casing 22 of the magnetic sensor device 4 can be precisely positioned relative to the substrate 2 and the multiple magnetic sensors 20 can be precisely positioned relative to the magnetic field-generating member 3 without affecting the positional relationship between the optical disk 5 and the optical sensor 6.

As a result of attaching the casing 22 to the substrate 2, the magnetic field-generating member 3 is disposed inside the second adjustment hole 41 of the casing 22 in such a manner as to be free of contact with the casing 22. The three magnetic sensors 20 and three yokes 21 are disposed on the outer periphery of the magnetic field-generating member 3 while keeping the predetermined positional relationship. For example, the three magnetic sensors 20 are disposed at the outer periphery of the magnetic field-generating member 3 at 120-degree intervals in the direction of rotation of the magnetic field-generating member 3. In addition, each magnetic sensor 20 is disposed in such a way that the direction of extension of the magnetic wire rod 30 is parallel to the top face of the substrate 2. Furthermore, when the substrate 2 is viewed from above, each magnetic sensor 20 is disposed in such a manner that the central portion of the magnetic wire rod 30 in the direction of extension (strictly speaking, the central portion of the central axis of the magnetic wire rod 30 in the direction of extension) is tangential to a predefined circle coaxial with the second adjustment hole 41 at the outer periphery of the magnetic field-generating member 3. In addition, the three yokes 21 are also disposed at 120-degree intervals in the direction of rotation of the magnetic field-generating member 3, with each yoke 21 disposed in such a way as to lie adjacent to a magnetic sensor 20 at the inner periphery of said magnetic sensor 20.

In this manner, the predetermined positional relationship of the magnetic field-generating member 3, three magnetic sensors 20, and three yokes 21, which are used for sensing the rotation of the rotary shaft 100, is established in one step without affecting the positional relationship between the optical disk 5 and the optical sensor 6, simply by attaching the casing 22 to the substrate 2.

As noted above, in accordance with the present embodiment, a rotation sensing device 1 that senses the rotation of a rotary shaft 100 (rotating body) comprises a single substrate 2 having an insertion hole 10 into which the rotary shaft 100 is inserted, a magnetic field-generating member 3 rotating with the rotation of the rotary shaft 100, multiple magnetic sensors 20 disposed around the periphery of the magnetic field-generating member 3, a casing 22 which accommodates the multiple magnetic sensors 20 and is provided on the substrate 2, an optical sensor 6 provided on the substrate 2 on the side facing away from the multiple magnetic sensors 20, and an optical disk 5 which is disposed facing the substrate 2, with the optical sensor 6 interposed therebetween, and which rotates with the rotary shaft 100. The rotation sensing device 1 has an adjustment mechanism capable of adjusting the position of the multiple magnetic sensors 20 relative to the magnetic field-generating member 3 by adjusting the position of the casing 22 relative to the substrate 2 once the position of the optical sensor 6 relative to the optical disk 5 has been adjusted and the substrate 2 has been precisely positioned.

For this reason, the rotation sensing device 1 allows for the design positional relationship between the magnetic field-generating member 3 and the magnetic sensors 20, which are used for sensing the rotation of the rotary shaft 100, to be readily adjusted and for the magnetic sensors 20 to be attached without affecting the positional relationship between the optical disk 5 and the optical sensor 6, simply by attaching the casing 22 to the substrate 2 on which the optical sensor 6 is provided.

Specifically, according to the present embodiment of the rotation sensing device 1, the device comprises coupling members 14 that couple the casing 22 and the substrate 2, the substrate 2 has coupling holes 13 through which the coupling members 14 are inserted, and the casing 22, as an adjustment mechanism, has first adjustment holes 40, which are formed with a diameter larger than that of the coupling members 14 by a predetermined adjustment width and through which the coupling members 14 are inserted. For this reason, the casing 22 can be adjusted by moving with respect to the substrate 2 in a direction perpendicular to the direction of insertion of the coupling members 14 (in a direction parallel to the plane of the substrate 2) without affecting the positional relationship between the optical disk 5 and the optical sensor 6. In this case, in comparison to when the coupling members 14 inserted through the coupling holes 13 and the first adjustment holes 40 are coaxially aligned, it becomes possible to adjust the position of the casing 22 relative to the substrate 2 with a degree of freedom defined by the adjustment width of the first adjustment holes 40. Accordingly, it is possible to adjust the position of the magnetic sensors 20 accommodated in the casing 22 relative to the magnetic field-generating member 3.

Furthermore, in accordance with the present embodiment of the rotation sensing device 1, as an adjustment mechanism, the casing 22 has a second adjustment hole 41, which is formed with a diameter larger than the insertion hole 10 by a predetermined adjustment width and into which the rotary shaft 100 and the magnetic field-generating member 3 are inserted. By this means, the casing 22 can be adjusted by moving with respect to the substrate 2 in a direction perpendicular to the axis of rotation of the rotary shaft 100 (in a direction parallel to the plane of the substrate 2) without affecting the positional relationship between the optical disk 5 and the optical sensor 6, in a manner as to maintain a sufficient clearance (e.g., a predetermined distance or more) from the magnetic field-generating member 3, with a degree of freedom defined by the adjustment width of the second adjustment hole 41, without permitting contact between the magnetic field-generating member 3 and the second adjustment hole 41.

Furthermore, in accordance with the present embodiment of the rotation sensing device 1, the magnetic sensors 20 and the substrate 2 each comprise terminals 33 (first terminals) and conductor portions 15 (second terminals) that are placed in mutual contact and, as an adjustment mechanism, the terminals 33 are formed as compression terminals while the conductor portions 15 are formed with an area of contact larger than that of the compression terminals by a predetermined adjustment width. By this means, the terminals 33 and the conductor portions 15 can be kept in contact and the electrical connection between the terminals 33 and conductor portions 15 can be maintained even if the casing 22 is adjusted by moving with respect to the substrate 2 in a direction parallel to the plane of the substrate 2.

Furthermore, soldering, such as reflow soldering, is not required to connect the terminals 33 to the conductor portions 15. In addition, since each magnetic sensor 20 is secured to the substrate 2 due to the fact that the casing 22 is coupled to the substrate 2 by the coupling members 14, soldering is not required to secure the casing 22 and each magnetic sensor 20 to the substrate 2. Accordingly, in the present embodiment, upon assembly of the substrate 2, to which the magnetic sensor device 4 has not been mounted yet, with the housing 101 of the motor, the magnetic sensor device 4 can be mounted to the substrate 2 and, when mounting the magnetic sensor device 4 to the substrate 2, the magnetic sensors 20 can be precisely positioned relative to the magnetic field-generating member 3. Furthermore, in the present embodiment, the magnetic sensors 20 are not subject to heat generated by soldering. In addition, in accordance with the present embodiment, no deviations occur because of soldering from the design position of the casing 22 relative to the substrate 2 or from the design position of the magnetic sensors 20 relative to the magnetic field-generating member 3.

Furthermore, due to the fact that in accordance with the present embodiment the magnetic sensors 20 are precisely positioned relative to the magnetic field-generating member 3 and the magnetic sensor device 4 is mounted to the substrate 2 after having assembled the substrate 2 with the housing 101 of the motor, even if the substrate 2 is offset from the design position with respect to the housing 101 of the motor when the substrate 2 is assembled with the housing 101, the misalignment of the substrate 2 relative to the housing 101 can be absorbed by adjusting the position of the magnetic sensors 20 relative to the magnetic field-generating member 3 when the magnetic sensor device 4 is mounted to the substrate 2. In other words, even if the substrate 2 is out of alignment with respect to the housing 101, the magnetic sensor device 4 can be disposed such that the position of the magnetic sensors 20 relative to the magnetic field-generating member 3 will correspond to the design position.

In addition, in accordance with the present embodiment, even after coupling the magnetic sensor device 4 to the substrate 2, the position of the magnetic sensor device 4 can be readily adjusted without affecting the positional relationship between the optical disk 5 and the optical sensor 6 by loosening or removing the coupling members 14, and in addition, the magnetic sensor device 4 can be detached from the motor and re-attached to the motor without detaching the substrate 2 from the housing 101.

Furthermore, in the present embodiment, the three magnetic sensors 20 are accommodated in the casing 22 and, within the casing 22, the three magnetic sensors 20 are disposed and secured at predetermined locations used for sensing the rotation of the rotary shaft 100. Specifically, within the casing 22, the three magnetic sensors 20 are disposed in one reference plane located coplanar with the bottom face of the casing 22 at 120-degree intervals in the circumferential direction around the second adjustment hole 41 in such a manner that the direction of extension of the magnetic wire rods 30 is parallel to the reference plane. Therefore, the predetermined design positional relationship of the magnetic field-generating member 3 and the three magnetic sensors 20, which are used for sensing the rotation of the rotary shaft 100, can be determined in one step and with high precision, simply by mounting the casing 22 to the substrate 2. This makes it possible to perform the mounting of the three magnetic sensors 20 to the substrate 2 with greater ease and with greater precision than, for example, by determining the position of the magnetic sensors 20 relative to the magnetic field-generating member 3 on an individual basis for each magnetic sensor 20.

Furthermore, in the present embodiment, in addition to the three magnetic sensors 20, three yokes 21 are accommodated in the casing 22 and, within the casing 22, the three magnetic sensors 20 and three yokes 21 are disposed and secured at predetermined locations used for sensing the rotation of the rotary shaft 100. Therefore, the predetermined design positional relationship of the magnetic field-generating member 3, three magnetic sensors 20, and three yokes 21, which are used for sensing the rotation of the rotary shaft 100, can be determined in one step and with high precision, simply by mounting the casing 22 to the substrate 2.

It should be noted that while the embodiment above describes an example in which, within the casing 22 of the magnetic sensor device 4, the three magnetic sensors 20 are disposed at 120-degree intervals and, in addition, the three yokes 21 are also disposed at 120-degree intervals, the placement of the three magnetic sensors 20 and the placement of the three yokes 21 in the present invention is not limited to this example. For example, within the casing 22 of the magnetic sensor device 4, the three magnetic sensors 20 can be disposed at predetermined angular intervals of less than 120 degrees (for example, 60 degrees) and, in addition, the three yokes 21 can be disposed at the same angular intervals.

In addition, while the aforementioned embodiment describes an example in which the three magnetic sensors 20 are disposed in the casing 22 in such a manner that, when the substrate 2 is viewed from above, the central portions of the magnetic wire rods 30 in the direction of extension are tangential to a predefined circle coaxial with the second adjustment hole 41 on the outer periphery of the magnetic field-generating member 3, the present invention is not limited to this example. For example, the three magnetic sensors 20 may be disposed in such a manner that each magnetic wire rod 30 is transverse to the circumference of said predefined circle. It should be noted that in the event of such placement, the placement of the magnetic field-generating member 3 (the magnetic poles or magnets used to form a rotating magnetic field) within the rotation sensing device 1 will also be different. As far as the placement of the magnetic field-generating member 3 is concerned, Japanese Patent Application Publication No. 2019-200098 should be useful as a reference. Alternatively, still other implementations can be adopted for the placement of the multiple magnetic sensors 20.

Furthermore, while the embodiment above describes an example in which the reference plane in which the three magnetic sensors 20 are disposed is coplanar with the bottom face of the casing 22, the present invention is not limited to this example. For example, as long as it is parallel to the bottom face of the casing 22, the reference plane can be a plane located above or below the bottom face of the casing 22. In such a case, the vertical position of the three magnetic sensors 20, or the vertical position of the contact portion 33d of each terminal 33, etc., is adjusted in such a way as to ensure the stability of attachment of the magnetic sensor device 4 to the substrate 2, as well as contact between each terminal 33 and the conductor portions 15.

In addition, in the present invention, the number of the magnetic sensors 20 provided in the casing 22 of the magnetic sensor device 4 is not limited to three, and may also be one, two, four or more. The same applies to the yokes 21. Alternatively, in the present invention, the magnetic sensor device 4 may be configured without providing yokes 21 within the casing 22.

While the embodiment above describes an example in which bolts and other coupling members 14 are fastened to the support posts 102 of the housing 101 for coupling the casing 22 and the substrate 2, the present invention is not limited to this example, and the coupling members 14 may couple the casing 22 and the substrate 2 by tightening to nuts and the like on the bottom face of the substrate 2. Furthermore, the coupling members 14 used to couple the casing 22 to the substrate 2 are not limited to bolts and may be, for example, rivets, clips, and the like. In addition, the present invention can be used for purposes other than sensing the rotation of a rotary shaft 100.

It should be noted that while the embodiment above describes an example in which the conductor portions 15 are formed with an area of contact that is larger than that of the terminals 33 provided in the magnetic sensors 20 by a predetermined adjustment width, the present invention is not limited to this example. For example, the terminals 33 provided in the magnetic sensors 20 may be formed with an area of contact larger than that of the conductor portions 15 by a predetermined adjustment width.

In addition, while the embodiment above describes an example in which the magnetic sensors 20 comprise terminals 33 having a single contact portion 33d, the present invention is not limited to this example. For example, instead of terminals 33 with a single contact portion 33d, the magnetic sensors 20 may comprise terminals 34 with multiple contact portions 34d, specifically, as shown in FIG. 14, terminals 34 formed as compression terminals with two contact portions 34d. The terminals 34 comprise a base portion 34a, an electrical wire connecting portion 34b, two spring portions 34c, and two contact portions 34d.

The base portion 34a is formed in the shape of a plate elongated in the forward-backward direction. The electrical wire connecting portion 34b is formed extending rearwardly from the rear end portion of the base portion 34a, and has an end portion of the insulated wire of the coil 32, stripped of its insulating jacket, connected thereto. Each spring portion 34c, which is a flat spring used to displace a contact portion 34d in the up-down direction, is, for example, bent downwardly from the front end of the base portion 34a and then bent to the rear, after which it extends rearwardly while sloping downward. Of the two spring portions 34c, one spring portion 34c extends from the left front end of the base portion 34a, and the other spring portion 34c extends from the right front end of the base portion 34a. The contact portions 34d are sections that make contact with conductor portions 15 provided on the top face of the substrate 2 when the magnetic sensor device 4 is coupled to the substrate 2. Each contact portion 34d is provided at the rear bottom end of a spring portion 34c and, for example, is formed so as to curve upwardly from the rear bottom end of the spring portion 34c.

The terminals 34, which comprise two spring portions 34c and two contact portions 34d, are constructed to allow the two contact portions 34d to make contact with a single conductor portion 15 provided on the substrate 2. In other words, the terminals 34 have two contact points that are each intended for a single conductor portion 15. Furthermore, the two spring portions 34c are capable of resilient deformation independently of each other and, therefore, the two contact portions 34d are capable of displacement in the up-down direction independently of each other. The thus configured terminals 34 can increase the reliability of contact with the conductor portions 15.

In addition, while the embodiment above describes an example in which the magnetic sensors 20 comprise terminals 33 or terminals 34, which are compression terminals, and the substrate 2 comprises pads and other conductor portions 15 that are placed in contact with the terminals 33 or terminals 34, the present invention is not limited to this example. For example, the substrate 2 may be adapted to comprise compression terminals and the magnetic sensors 20 may be adapted to comprise pads or other conductors.

Furthermore, while the embodiment above describes an example in which the first adjustment holes 40 provided in the casing 22 of the magnetic sensor device 4 are formed with a diameter larger than that of the coupling members 14 by a predetermined adjustment width, such that the casing 22 is adjustable with respect to the substrate 2 in all horizontal directions, the present invention is not limited to this example. For example, the first adjustment holes 40 may be formed extending circumferentially about the second adjustment hole 41 such that the casing 22 can be adjusted with respect to the substrate 2 only in the circumferential direction.

In addition, in the present invention, appropriate modifications are feasible without departing from the gist or concept of the invention that can be read from the Claims and Specification as a whole, and rotation sensing devices associated with such modifications are also included in the technical concept of the present invention.

### Description of the Reference Numerals

1 Rotation sensing device

2 Substrate

3 Magnetic field-generating member

4 Magnetic sensor device

5 Optical disk

6 Optical sensor

10 Insertion hole

11 Securing hole

12 Securing member

13 Coupling hole

14 Coupling member

15 Conductor portion

20 Magnetic sensor

21 Yoke

22 Casing

30 Magnetic wire rod

31 Bobbin

32 Coil

33, 34 Terminals

40 First adjustment hole

41 Second adjustment hole

42 Positioning reference hole

100 Rotary shaft

101 Housing

1. A rotation sensing device, which is a rotation sensing device for sensing the rotation of a rotating body, comprising:
a single substrate having an insertion hole into which the rotating body is inserted;
a magnetic field-generating member rotating with the rotation of the rotating body;
a plurality of magnetic sensors disposed around the magnetic field-generating member;
a casing which accommodates the plurality of magnetic sensors and is provided on the substrate;
an optical sensor provided on the substrate on the side facing away from the plurality of magnetic sensors; and
an optical disk which is disposed facing the substrate, with the optical sensor interposed therebetween, and which rotates with the rotation of the rotating body,
wherein said device has an adjustment mechanism capable of adjusting the position of the plurality of magnetic sensors with respect to the magnetic field-generating member by adjusting the position of the casing relative to the substrate once the position of the optical sensor relative to the optical disk has been adjusted and the substrate has been precisely positioned.

2. The rotation sensing device according to claim 1 comprising coupling members coupling the casing and the substrate,
wherein the substrate has coupling holes, through which the coupling members are inserted, and
as the adjustment mechanism, the casing has first adjustment holes which are formed with a diameter larger than the coupling members by a predetermined adjustment width and through which the coupling members are inserted.

3. The rotation sensing device according to claim 2 wherein, as the adjustment mechanism, the casing has a second adjustment hole which is formed with a diameter larger than that of the insertion hole by a predetermined adjustment width and into which the rotating body and the magnetic field-generating member are inserted.

4. The rotation sensing device according to claim 2, wherein the magnetic sensors and the substrate each comprise first terminals and second terminals that are placed in mutual contact, and
as the adjustment mechanism, one of the first terminals or the second terminals is formed as a compression terminal, and another of the first terminals or the second terminals is formed as a conductor portion whose area of contact is larger than the compression terminal by a predetermined adjustment width.
